(19) United States
(12) Patent Application Publication
(10) Pub. No.: US 2005/0096420 A1
(43) Pub. Date: May 5, 2005

(54) Luminescent plastics

(76) Inventors: Reiner Delp, Darmstadt (DE); Rainer Linzmeier, Gross-Zimmern (DE)

Correspondence Address: MILLEN, WHITE, ZELANO & BRANIGAN, P.C., 2200 CLARENDON BLVD., SUITE 1400, ARLINGTON, VA, 22201, US

(21) Appl. No.: 10/979,260

(22) Filed: Nov. 3, 2004

(30) Foreign Application Priority Data
Nov. 3, 2003 (DE) 103 51 217.9

(51) Int. Cl. C08K 3/18; C08K 3/34; C08K 3/40; C08K 5/15

(52) U.S. Cl. 524/430; 524/449; 524/494; 524/439

(57) ABSTRACT

The present invention relates to coloured plastics having improved luminescence properties comprising one or more luminescent colorants and one or more transparent and/or semitransparent effect pigments, to a process for the preparation of these plastics, and to mouldings produced therefrom.

The present invention relates to coloured plastics having improved luminescence properties comprising one or more luminescent colorants and one or more transparent and/or semitransparent effect pigments, to a process for the preparation of these plastics, and to mouldings produced therefrom.

The use of luminescent colorants in plastics has been known for some time. Thus, EP 612 772 describes luminescent copolymers built up from luminescent complex salts of rare-earth metals having a polymerisable double bond and free-radical-polymerisable comonomers, where the phosphorescence of the organic complex ligands is transferred to rare-earth metal ions, which then themselves emit the absorbed energy as fluorescence. The products are employed in medical diagnostics.

DE 44 24 817 describes fluorescent pigments essentially comprising a polymer matrix based on polymethyl methacrylate and a nonpolar fluorescent dye from the coumarin or perylene series and the use thereof for the production of mouldings and films.

EP 25 136 discloses light collector systems containing coumarin derivatives, where the light collector systems can be plastic mouldings. DE 25 29 434 describes analogously fluorescent coumarin dyes and the use thereof in plastics.

Plastics coloured in this way are employed, for example, in safety signs, escape-route markings, toys, etc. However, they have the disadvantage that plastics provided purely with luminescent colorants only have an unattractive appearance.

The addition of colorants for colouring and effect adjustment of luminescent systems of this type can only be achieved with significant impairment of the luminescence properties, such as, for example, the phosphorescence properties, or is totally impossible. This greatly restricts the applicability of such plastics.

Thus, JP 11-151322 discloses the use of fluorescent pigments in combination with mica and titanium dioxide in plastics for the production of pearlescent golf balls. However, the proportion of titanium dioxide, which is intended to lighten the colour of the golf ball, has an adverse effect on the luminescence properties of the golf-ball coatings, since titanium dioxide, as an opaque material, adversely affects the phosphorescence properties.

JP 07-258460 describes plastics comprising metallic pigments, such as, for example, metal foils or metal-coated glass flakes, and fluorescent pigments. Owing to the high hiding power of the metal-containing pigments, large proportions of fluorescent pigments are necessary, which disadvantageously increase the costs for the use of these mixtures in the plastics. In addition, only plastics with a metallic lustre can be prepared using these combinations; colouring, which is frequently desired, is not possible.

The object was therefore to provide luminescent plastics which are both luminescent and are coloured, even under daylight, without the colouring adversely affecting the luminescence properties.

Surprisingly, it has been found that the plastics according to the invention meet this complex requirement profile. The invention therefore relates to coloured plastics having improved luminescence properties, where the plastics comprise one or more luminescent colorants and one or more transparent and/or semitransparent effect pigments.

The coloured plastics according to the invention having improved luminescence properties have the advantage that they can be coloured through the use of transparent and/or semitransparent effect pigments without adversely affecting the luminescence properties. In addition, the use of transparent and/or semitransparent effect pigments enables the plastics to be provided with a particular colouring which cannot be achieved in other ways, for example through interference phenomena and a colour flop between at least two colours which is visible at different viewing angles. In daylight, the transparent and/or semitransparent effect pigments determine the appearance of the plastics, and in darkness, the pronounced light-storage and phosphorescence properties of the luminescent colorants can advantageously be utilised. Owing to the combination of luminescent properties and colouring in daylight, the plastics according to the invention and mouldings produced therefrom are suitable for all areas of application, such as, for example, in toys, sports articles, in architecture, in domestic articles, in electronic articles, in fashion jewellery, in safety signs, etc.

Transparent and/or semitransparent effect pigments which can be employed in accordance with the present invention are based, in particular, on supports, which can have any regular or irregular shape and are preferably in flake form. Particularly preferred supports are flake-form TiO₂, synthetic or natural mica, glass flakes, flake-form SiO₂, Al₂O₃ or flake-form iron oxide. In a preferred embodiment, the support may have been coated with one or more transparent and/or semitransparent layers comprising metal oxides, metal oxide hydrates, metal suboxides, metals, metal fluorides, metal nitrides, metal oxynitrides or mixtures of these materials. The metal oxide, metal oxide hydrate, metal suboxide, metal, metal fluoride, metal nitride or metal oxynitride layers or the mixtures thereof can have low refractive indexes (refractive index <1.8) or high refractive indexes (refractive index ≧1.8). Suitable metal oxides and metal oxide hydrates are all metal oxides and metal oxide hydrates known to the person skilled in the art, such as, for example, aluminium oxide, aluminium oxide hydrate, silicon oxide, silicon oxide hydrate, iron oxide, tin oxide, cerium oxide, zinc oxide, zirconium oxide, chromium oxide, titanium oxide, in particular titanium dioxide, titanium oxide hydrate and mixtures thereof, such as, for example, ilmenite or pseudobrookite. Metal suboxides which can be employed are, for example, titanium suboxides. Suitable metals are, for example, chromium, aluminium, nickel, silver, gold, titanium, copper or alloys, and a suitable metal fluoride is, for example, magnesium fluoride. Metal nitrides or metal oxynitrides which can be employed are, for example, the nitrides or oxynitrides of the metals titanium, zirconium and/or tantalum. Preference is given to the application of metal oxide, metal, metal fluoride and/or metal oxide hydrate layers and very particularly preferably metal oxide and/or metal oxide hydrate layers to the support. Furthermore, multilayered structures comprising high- and low-refractive-index metal oxide, metal oxide hydrate, metal or metal fluoride layers may also be present, preferably with high- and low-refractive-index layers alternating. Particular preference is given to layer packages comprising a high-refractive-index layer and a low-refractive-index layer, it being possible for one or more of these layer packages to be applied to the support. The sequence of the high- and low-refractive-index layers can be matched to the support here in order to include the support in the multilayered structure. In a further embodiment, the metal oxide, metal oxide hydrate, metal suboxide, metal, metal fluoride, metal nitride or metal oxynitride layers can be mixed or doped with colorants or other elements. Suitable colorants or other elements are, for example, organic or inorganic coloured pigments, such as coloured metal oxides, for example magnetite or chromium oxide, or coloured pigments, such as, for example, Berlin Blue, ultramarine, bismuth vanadate, Thenard's Blue, or alternatively organic coloured pigments, such as, for example, indigo, azo pigments, phthalocyanines or alternatively Carmine Red, or elements, such as, for example, yttrium or antimony. The addition of the colorants or the doping with elements should not significantly affect the transparency of the effect pigments here in order that the phosphorescence properties of the luminescent colorants are not impaired. Effect pigments comprising these layers exhibit a wide variety of colours with respect to their mass tone and can in many cases exhibit an angle-dependent change in the colour (colour flop) due to interference.

In a preferred embodiment, the outer layer on the support is a high-refractive-index metal oxide. This outer layer may additionally be on the above-mentioned layer packages or may be part of a layer package in high-refractive-index supports and can, for example, consist of TiO₂, titanium suboxides, Fe₂O₃, SnO₂, ZnO, ZrO₂, Ce₂O₃, CoO, CO₃O₄, Cr₂O₃ and/or mixtures thereof, such as, for example, ilmenite or pseudobrookite. TiO₂ is particularly preferred.

Examples and embodiments of the above-mentioned materials and pigment structures are also given, for example, in Research Disclosures RD 471001 and RD 472005, the disclosure content of which is incorporated herein by way of reference.

The thickness of the metal oxide, metal oxide hydrate, metal suboxide, metal, metal fluoride, metal nitride or metal oxynitride layers or a mixture thereof is usually from 3 to 300 nm and in the case of the metal oxide, metal oxide hydrate, metal suboxide, metal fluoride, metal nitride or metal oxynitride layers or a mixture thereof is preferably from 20 to 200 nm. The thickness of the metal layers is preferably from 4 to 50 nm and must be selected so that the transparency or semitransparency of the pigments is retained.

The size of the supports and thus of the effect pigments is not crucial per se. Flake-form supports and/or flake-form supports coated with one or more transparent or semitransparent metal oxide, metal or metal fluoride layers generally have a thickness of between 0.05 and 5 μm, in particular between 0.1 and 4.5 μm. The dimension in the length or width is usually between 1 and 250 μm, preferably between 2 and 200 μm and in particular between 2 and 100 μm.

The transparency of the effect pigments which can be employed in accordance with the present invention is greater than 20%, preferably greater than 50%, based on the individual particles and on white light from a quartz lamp. Methods for the determination of the transparency of small flakes are known to the person skilled in the art and instruments for this purpose are commercially available. For example, a microspectrometer from the SEE 1000 series from SEE Inc., Middleborough, Mass., USA, is suitable.

Luminescent colorants which are suitable in the present invention are all organic or inorganic luminescent dyes or pigments known to the person skilled in the art which exhibit fluorescence or phosphorescence. Examples of organic luminescent dyes or pigments are those from the group consisting of the naphthalimides, coumarins, xanthenes, thioxanthenes, naphtholactams, azlactones, methines, oxazines, thiazines, such as, for example, sulfoflavine, 7-dialkylcoumarin, fluorescein, rhodamine, benzoxanthene, samarone, naphthostyril, flavines, fluorol, but also the pigments known under the names Solvent Yellow 44, Solvent Yellow 160, Basic Yellow 40, Basic Red 1, Basic Violet 10 and Acid Red 52. Further examples are given, inter alia, in Ullmann's Encyclopedia of Industrial Chemistry, Internet Edition, 7th Edition, 2003.

Examples of inorganic luminescent dyes or pigments are corresponding sulfides, such as, for example, CaS:Bi, CaSrS:Bi, ZnS:Cu, ZnS:Pb²⁺, ZnS:Mn²⁺, ZnCdS:Cu, AB₂S₄ (where A=alkaline earth metal; B=aluminium), ZnS, ZnS:Ag, ZnS:Cu:Cl, ZnS:Cu:Al, (Ce₃(SiS₄)₂X (where X=Cl, Br, I), La₃₋ₓCeₓ(SiS₄)₂I (where 0≦x≦1), SrS:Cr, SrS doped with rare-earth metals or Mn, CdS:Mn, Y₂O₂S:(Er,Yb), also fluorides, such as, for example, AF₃ (where A=La³⁺, Ce³⁺, Y³⁺, Al³⁺, Mg²⁺, Ca²⁺, Pb²⁺ and containing at least one luminescent ion selected from the group consisting of the trivalent ions (Cr³⁺, Fe³⁺, etc.) or rare earths (Y³⁺, Pr³⁺, Nd³⁺, Sm³⁺, Eu³⁺, Tb³⁺, Dy³⁺, Ho³⁺, Er³⁺, Tm³⁺, Yb³⁺)), LnF₃, ALnF₄, AeLn₂F₈, ALn₃F₁₀ (where Ln=rare earths and yttrium, A monovalent alkali metal ion, Ae=divalent alkaline earth or transition metal ion, such as, for example, Mg²⁺, Ca²⁺, Sr²⁺, Ba²⁺, Zn²⁺ and containing at least one luminescent ion selected from the group consisting of the trivalent ions (Cr³⁺, Fe³⁺, etc.) or rare earths (Y³⁺, Pr³⁺, Nd³⁺, Sm³⁺, Eu³⁺, Tb³⁺, Dy³⁺, Ho³⁺, Er³⁺, Tm 3+, Yb³⁺)), EF₃ (E=Ga³⁺, In³⁺, Bi³⁺ and containing at least one luminescent ion selected from the group consisting of the trivalent ions (Cr³⁺, Fe³⁺, etc.) or rare earths (Y³⁺, Pr³⁺, Nd³⁺, Sm³⁺, Eu³⁺, Tb³⁺, Dy³⁺, Ho³⁺, Er³⁺, Tm³⁺, Yb³⁺)), Sr₁₋ₓEu²⁺ₓSiF₆.2H₂O (where 0<x≦0.5), M₁₋ₓEuₓ²⁺SiF₆ (where 0<x≦0.2 and M is at least one ion selected from barium and strontium), K₂YF₅ (doped with Gd³⁺, Tb³⁺, Eu³⁺ or Pr³⁺), LiYF₄ (doped with Gd³⁺, Tb³⁺, Eu³⁺ or Pr³⁺), NaLnF₄ (where Ln=lanthanoid or Y), NaYF₄:Pr³⁺, Na(Y,Yb)F₄:Pr³⁺, Na₃AlF₆ (containing at least one luminescent ion selected from the group consisting of the trivalent ions (Cr³⁺, Fe³⁺, etc.) or rare earths (Y³⁺, Pr³⁺, Nd³⁺, Sm³⁺, Eu³⁺, Tb³⁺, Dy³⁺, Ho³⁺, Er³⁺, Tm³⁺, Yb³⁺)), BaLiF₃:Eu³⁺, BaY₂F₈:Eu³⁺, BaSiF₆:Eu³⁺, α-NaYF₄:Pr³⁺ or LiGdF₄:Eu³⁺. Also suitable are luminescent oxides, such as, for example, MAl₂O₄ (where M=one or more metals selected from calcium, strontium and barium, the matrix may be doped with europium as activator and may optionally contain other rare earths, such as, for example, lanthanum, cerium, praesodymium, neodymium, samarium, gadolinium, dysprosium, holmium, erbium, thulium, ytterbium, lutetium or tin and bismuth as coactivator(s), as in SrAl₂O₄(Eu²⁺,Dy³⁺)), (M′ₓM″_{y})Al₂O₄ (where x+y=1 and M′ and M″ are different and are selected from calcium, strontium and barium, the matrix may be doped with europium as activator and may optionally contain other rare earths, such as, for example, lanthanum, cerium, praesodymium, neodymium, samarium, gadolinium, dysprosium, holmium, erbium, thulium, ytterbium, lutetium or tin and bismuth as coactivator(s)), M₁₋ₓAl₂O₄₋ₓ (where M is at least one metal selected from calcium, strontium and barium or in which M comprises magnesium and at least one metal selected from calcium, strontium and barium, and X is not zero, the matrix may be doped with europium as activator and may optionally contain other rare earths, such as, for example, lanthanum, cerium, praesodymium, neodymium, samarium, gadolinium, dysprosium, holmium, erbium, thulium, ytterbium, lutetium or tin and bismuth as coactivator(s)), LnBO₃ (where Ln=at least one element of the rare earths), M(II)₁₋ₓEu(II)ₓM(III)ₚEu(III)_{q}Tb(III)ᵣB₉O₁₆ (where M(II) is at least one bivalent metal selected from barium, strontium, lead and calcium, M(III) is selected from lanthanum, gadolinium, yttrium, cerium, lutetium and bismuth, 0≦x≦0.2, p, q and r are not zero and p+q+r=1), Ln₁₋ₓTbₓMgB₅O₁₀ (where Ln=at least one element selected from the rare earths and/or yttrium and 0<x≦1), M₅₍₁₋ₐ₎Eu₅ₐ²⁺Si₄X₆ (where M=Ba_{1-b}Sr_{b} or Ba_{1-b}Ca₆₂, where 0≦b≦0.1 and 0≦a≦0.2 and X=Cl_{1-c}Br_{c} where 0≦c≦1), La₁₋ₓSmₓOBr (where 0<x≦0.1), Zn_{3.5}Y_{0.92}Eu_{0.08}O₅, ZnO:Zn, ZnO:Ga₂O₃:Bi, CaTiO₃:Pr³⁺, La₂TiO₅:Pr³⁺, La₂Ti₂O₇:Pr³⁺, (La,Pr)₂Ti₂O₇, (La,Yb,Pr)₂Ti₂O₇, YBO₃:(Eu³⁺, Tb³⁺, Gd³⁺), Y₃BO₆:Eu³⁺, LnBO₃ (doped with Eu³⁺, Tb³⁺, Pr³⁺ or Tm³⁺, doped or co-doped with Ce³⁺ or Gd³⁺ and Eu³⁺, Tb³⁺, Tm³⁺ or Pr³⁺), Ln₃BO₆ (doped with Eu³⁺, Tb³⁺, Pr³⁺ or Tm³⁺, doped or co-doped with Ce³⁺ or Gd³⁺ and Eu³⁺, Tb³⁺, Tm³⁺ or Pr³⁺), Ln(BO₂)₃ (doped with Eu³⁺, Tb³⁺, Pr³⁺ or Tm³⁺, doped or co-doped with Ce³⁺ or Gd³⁺ and Eu³⁺, Tb³⁺, Tm³⁺ or Pr³⁺), SiO₂ (doped with rare earths), SiO₂:(Sm³⁺,Al³⁺), Al_{(2-x-y)}(Y,Ln)ₓO₃:yM (where M=Cr₂O₃, V₂O₅, NiO, WO₃, CuO, FeO, Fe₂O₃ and Ln=Er, La, Yb, Sm, Gd and mixtures thereof and 0.48≦x<≦1.51 and 0.007≦y≦0.2), Al₂O₃ (doped with rare earths), phosphate glasses (doped with rare earths), LiNbO₃ (doped with rare earths), TiO₂ (doped with rare earths), LaPO₄:Ce and/or Tb, LaPO₄:Eu, CePO₄:Tb, MAl₂B₂O₇:Eu²+ (where M=Sr, Ca), M₂B₅O₉X:Eu (where M=Ca, Sr, Ba and X=Cl, Br), CaSO₄:Eu, CaSO₄:Eu, LaMgB₅O₁₀:Ce or Mn, Y₂O₃:Eu, Gd₂O₃:Eu, (Y_{0.7}Gd_{0.3})₂O₃:Eu, CoAl₂O₄, Mg₄GeO_{5.5}F:Mn, (Sr,Mg)₃(PO₄)₂:Sn, Y₃Al₅O₁₂:Ce, Y(V,B,P)O₄:Eu, BaMgAl₁₀O₁₇:Eu, BaMg₂Al₁₆O₂₇:Eu, (Ce,Tb)MgAl₁₁O₁₉, (Ce,Gd,Tb)MgB₅O₁₀, (Ce,Gd,Tb)MgB₅O₁₀:Mn, LaPO₄:(Ce,Tb), Sr₂Al₁₄O₂₅:Eu, Ca₅(PO₄)₃(F,Cl):(Sb,Mn), (La,Ce,Tb)(PO₄)₃:(Ce,Tb), CeO_{0.65}TbO_{0.35}MgAl₁₁O₁₉, barium-titanium phosphates, (Ba,Sr,Ca)₂SiO₄:Eu, SrAl₁₂O₁₉:Ce, BaSi₂O₅:Pb, (Sr,Zn)MgSi₂O₇:Pb, SrB₄O₇:Eu, (Gd,La)B₃O₆:Bi, Sr₂P₂O₇:Eu, BaMgAl₁₀O₁₇:Eu, Mn, Zn₂SiO₄:Mn, YVO₄:(Eu,Sm,Dy), AWO₄ (where A=Ca, Ba, Pb, Cd, Zn, Mg), In₂O₃:(Er,Tb), GdAl(BO₃)₄:Nd, ZrO₂:Eu³⁺, GdVO₄:(Bi,Eu) and red phosphorus. Also suitable are nitrides or oxynitrides, such as, for example, GaN:Mg, Si₃N₄ (containing at least one luminescent ion selected from the group consisting of the trivalent ions (Cr³⁺, Fe³⁺, etc.) or rare earths (Y³⁺, Pr³⁺, Nd³⁺, Sm³⁺, Eu³⁺, Tb³⁺, Dy³⁺, Ho³⁺, Er³⁺, Tm³⁺, Yb³⁺)) or ZrₓO_{y}N_{z}:Eu³⁺ (where x>0, y>0 and z>0). Further examples are given, inter alia, in Ullmann's Encyclopedia of Industrial Chemistry, Internet Edition, 7th Edition, 2003. The luminescent colorant may of course also comprise mixtures of in each case one or more of the above-mentioned organic or inorganic luminescent dyes or pigments.

The plastic as base material for the coloured plastics having improved luminescence properties in accordance with the present invention can encompass all thermoplastics known to the person skilled in the art or mixtures thereof, as described, for example, in Ullmann's Encyclopedia of Industrial Chemistry, Vol. 15, pp. 457 ff., Verlag VCH. Examples of plastics which can be employed are polyethylene, polypropylene, polyamides, polyesters, polyester-esters, polyether-esters, polyphenylene ether, poly-acetal, polybutylene terephthalate, polymethyl methacrylate, polyvinyl acetate, polystyrene, acrylonitrile-butadiene-styrene (ABS), acrylonitrile-styrene-acrylate (ASA), polycarbonate, polyether-sulfones, polyether-ketones and copolymers or mixtures thereof.

The plastics can comprise all additives or auxiliaries known to the person skilled in the art and necessary for the processing of plastics. Examples of additives and auxiliaries are organic polymer-compatible solvents, stabilisers, surfactants and/or adhesives, such as, for example, diisooctyl phthalate, phenol derivatives, mineral oils. An overview of the additives and auxiliaries which can be employed is given by R. Wolf in “Plastics, Additives” in Ullmann's Encyclopedia of Industrial Chemistry, Internet Edition, 7th Edition, 2003.

In addition, the coloured plastics according to the invention having improved luminescence properties can comprise further colorants. These are preferably transparent colorants which do not influence the light-storage and phosphorescence properties of the plastics according to the invention. Examples of transparent colorants are organic dyes which are soluble in the plastic matrix, such as, for example, those mentioned in DIN 55944 or in the Colour Index, the contents of which are incorporated herein by way of reference. By addition of these and analogous colorants, the colouring can be varied in an extremely wide variety of forms in connection with the effect pigments.

The present invention furthermore relates to a process for the preparation of coloured plastics having improved luminescence properties in which one or more luminescent colorants and one or more transparent and/or semi-transparent effect pigments are added simultaneously or successively to a plastic. The luminescent colorants and the effect pigments are incorporated into the plastic by mixing plastic granules with the two components. The luminescent colorants and the effect pigments can be added simultaneously, successively, individually or as a mixture. The coloured plastic having improved luminescence properties is subsequently shaped under the action of heat. In a further embodiment, adhesives, organic polymer-compatible solvents, stabilisers and/or surfactants which are heat-stable under the working conditions can optionally be added to the plastic granules during incorporation of the luminescent colorants and the effect pigments. Examples of auxiliaries and additives of this type have already been mentioned above in the description of the plastics which can be employed. The plastic granules/pigment mixture is generally prepared by introducing the plastic granules into a suitable mixer, for example a drum or high-speed mixer, wetting the granules with any additives and then adding and mixing-in the pigments or pigment mixture. The mixture of luminescent colorants and effect pigments can also be employed in the form of masterbatches for the colouring of thermoplastics. In this way, the highest demands of pigment dispersal can also be met. The masterbatches can be prepared either continuously or batchwise, preferably continuously, for example through the use of twin-screw extruders.

In a further process according to the invention, transparent colorants are additionally added. These can likewise be introduced into the plastic individually or in combination with one of the above-mentioned ingredients. The plastic provided with luminescent colorants and with transparent and/or semitransparent effect pigments can then be shaped directly under the action of heat, for example in an extruder or injection-moulding machine. The mouldings formed during processing exhibit a very homogeneous distribution of the luminescent colorants and effect pigments. The present invention likewise relates to mouldings comprising the coloured plastics according to the invention having improved luminescence properties. The mouldings here can have any shape desired by the user, where the design of the mouldings, the use of the moulds and the optimisation of all steps necessary for the production thereof can be carried out within the bounds of expert knowledge.

The following examples are intended to explain the invention in greater detail, but without restricting it.

Without further elaboration, it is believed that one skilled in the art can, using the preceding description, utilize the present invention to its fullest extent. The preceding preferred specific embodiments are, therefore, to be construed as merely illustrative, and not limitative of the remainder of the disclosure in any way whatsoever.

In the foregoing and in the examples, all temperatures are set forth uncorrected in degrees Celsius and, all parts and percentages are by weight, unless otherwise indicated.

### EXAMPLES

### Example 1

Thermoplastic polypropylene (grade PPG 10 from DSM, Geelen) is mixed with 10% by weight of Lumilux® Effect Red N100 (Riedel de Haen) and 0.5% by weight of Iriodin® 355 (mica coated with titanium dioxide and iron oxide), based on the total amount, before the injection-moulding operation. Injection mouldings are produced from the mixture. Lustrous injection mouldings having a golden mass tone under daylight which exhibit red luminescence in darkness are obtained.

### Example 2

Thermoplastic polypropylene (grade PPG 10 from DSM, Geelen) is mixed with 15% by weight of Lumilux® Effect Red N100 (Riedel de Haen) and 0.8% by weight of Iriodin® 383 (mica coated with titanium dioxide, iron oxide and tin oxide), based on the total amount, before the injection-moulding operation. Injection mouldings are produced from the mixture. Lustrous injection mouldings having a golden mass tone under daylight which exhibit red luminescence in darkness are obtained.

### Example 3

Thermoplastic polypropylene (grade PPG 10 from DSM, Geelen) is mixed with 15% by weight of Lumilux® R (Riedel de Haen) and 0.8% by weight of Iriodin® 183 (mica coated with titanium dioxide and iron oxide), based on the total amount, before the injection-moulding operation. Injection mouldings are produced from the mixture. Lustrous injection mouldings having a silver mass tone under daylight which exhibit red luminescence in darkness are obtained.

### Example 4

Thermoplastic polypropylene (grade PPG 10 from DSM, Geelen) is mixed with 20% by weight of Proglow® 20 (Proglow) and 0.7% by weight of Iriodin® 249 (mica coated with titanium dioxide and iron oxide), based on the total amount, before the injection-moulding operation. Injection mouldings are produced from the mixture. Lustrous injection mouldings having a silver-white mass tone under daylight having a yellow interference effect which exhibit red luminescence in darkness are obtained.

### Example 5

Thermoplastic polypropylene (grade PPG 10 from DSM, Geelen) is mixed with 15% by weight of Super Luminova® (Luminova) and 0.8% by weight of Iriodin® 299 (mica coated with titanium dioxide and iron oxide), based on the total amount, before the injection-moulding operation. Injection mouldings are produced from the mixture. Lustrous injection mouldings having a silver-white mass tone under daylight having a green interference effect which exhibit red luminescence in darkness are obtained.

### Example 6

Thermoplastic polypropylene (grade PPG 10 from DSM, Geelen) is mixed with 20% by weight of Colour C9 (RC Tritec), 0.001% of a blue transparent dye (C.I. SV 13 Thermoplastic Blue 684, BASF AG) and 0.8% by weight of Iriodin® 183 (mica coated with titanium dioxide and iron oxide), based on the total amount, before the injection-moulding operation. Injection mouldings are produced from the mixture. Lustrous injection mouldings having a metallic blue mass tone under daylight which exhibit red luminescence in darkness are obtained.

### Comparative Example 1

Thermoplastic polypropylene (grade PPG 10 from DSM, Geelen) is mixed with 15% by weight of Lumilux® Effect Red N100 (Riedel de Haen), based on the total amount, before the injection-moulding operation. Injection mouldings are produced from the mixture. Injection mouldings having a pink mass tone under daylight which exhibit red luminescence in darkness are obtained.

### Comparative Example 2

Thermoplastic polypropylene (grade PPG 10 from DSM, Geelen) is mixed with 1% by weight of Lumilux® Effect Red N100 (Riedel de Haen) and 1.0% by weight of aluminium powder (Standart PCR 212, Eckhart), based on the total amount, before the injection-moulding operation. Injection mouldings are produced from the mixture. Injection mouldings having a silvery lustre which exhibit no luminescence in darkness are obtained.

### Comparative Example 3

Thermoplastic polypropylene (grade PPG 10 from DSM, Geelen) is mixed with 1% by weight of Lumilux® Effect Red N100 (Riedel de Haen) and 1.0% by weight of gold-bronze powder (Standart Resist LT, Eckhart), based on the total amount, before the injection-moulding operation. Injection mouldings are produced from the mixture. Injection mouldings having a silvery lustre which exhibit no luminescence in darkness are obtained.

The preceding examples can be repeated with similar success by substituting the generically or specifically described reactants and/or operating conditions of this invention for those used in the preceding examples.

The entire disclosures of all applications, patents and publications, cited herein and of corresponding German application No. 10351217.9, filed Nov. 3, 2003 are incorporated by reference herein.

From the foregoing description, one skilled in the art can easily ascertain the essential characteristics of this invention and, without departing from the spirit and scope thereof, can make various changes and modifications of the invention to adapt it to various usages and conditions.

1. A coloured plastic having improved luminescence properties, comprising one or more luminescent colorants and one or more transparent and/or semitransparent effect pigments.

2. A coloured plastic having improved luminescence properties according to claim 1, wherein the one or more luminescent colorants comprises one or more organic or inorganic luminescent dyes or one or more organic or inorganic luminescent pigments or a mixture thereof.

3. A coloured plastic having improved luminescence properties according to claim 1, wherein the transparent and/or semitransparent effect pigments are based on supports.

4. A coloured plastic having improved luminescence properties according to claim 3, wherein the supports are flake-form TiO₂, synthetic or natural mica, glass flakes, flake-form SiO₂, Al₂O₃ or flake-form iron oxide.

5. A coloured plastic having improved luminescence properties according to claim 3, wherein the support is coated with one or more transparent and/or semitransparent layers comprising metal oxides, metal oxide hydrates, metal suboxides, metals, metal fluorides, metal nitrides, or metal oxynitrides or mixtures of these materials.

6. A coloured plastic having improved luminescence properties according to claim 1, wherein the plastic comprises polyethylene, polypropylene, polyamides, polyesters, polyester-esters, polyether-esters, polyphenylene ether, polyacetal, polybutylene terephthalate, polymethyl methacrylate, polyvinyl acetate, polystyrene, acrylonitrile-butadiene-styrene, acrylonitrile-styrene-acrylate, polycarbonate, polyether-sulfones, or polyether-ketones or mixtures thereof.

7. A coloured plastic having improved luminescence properties according to claim 1, further comprising one or more transparent colorants.

8. A process for preparing coloured plastics having improved luminescence properties according to claim 1, comprising adding simultaneously or successively to a plastic one or more luminescent colorants and one or more transparent and/or semitransparent effect pigments.

9. A process according to claim 8, further comprising adding one or more transparent colorants to the plastic.

10. A process according to claim 8, further comprising adding auxiliaries to the plastic.

11. A process according to claim 8, further comprising shaping the plastic under the action of heat.

12. A moulded article comprising coloured plastic having improved luminescence properties according to claim 1.
